(19) United States
(12) Patent Application Publication
(10) Pub. No.: US 2006/0286989 A1
(43) Pub. Date: Dec. 21, 2006

(54) Geographical and calendar based advertising system and method

(76) Inventor: Brian Eli Berl Illion, Toronto (CA)

Correspondence Address: BERESKIN AND PARR, 40 KING STREET WEST, BOX 401, TORONTO, ON, M5H 3Y2, CA

(21) Appl. No.: 11/436,512

(22) Filed: May 19, 2006

Related U.S. Application Data
(60) Provisional application No. 60/682,838, filed on May 20, 2005.

(51) Int. Cl. H04Q 7/20

(52) U.S. Cl. 455/456.3; 455/414.1

(57) ABSTRACT

An advertising system and method for displaying an advertisement on the display of a mobile device on the basis of geographical and/or calendar characteristics of the mobile display. The mobile device is connected to a memory over a communications network, the memory for storing the advertisement and a predetermined geographical characteristic value. A processor is connected to the memory for selecting an advertisement based on whether the geographical and/or calendar characteristic of the mobile device matches the predetermined geographical and/or calendar characteristic value and for instructing the mobile device over the communications network to display the selected advertisement. Accounting information is compiled and includes the number of times that the selected advertisement is displayed, the times at which the selected advertisement is displayed, and the geographical characteristics associated with the mobile device when the selected advertisement is displayed.

This application claims the benefit under 35 U.S.C. 119(e) of U.S. Provisional Application No. 60/682,838, filed May 20, 2005.

### FIELD OF THE INVENTION

This invention relates to advertising systems and methods and more particularly to providing an advertising system and method that provides advertising content based on various geographical and calendar characteristics.

### BACKGROUND OF THE INVENTION

Advertising has traditionally been associated with moving vehicles. Under arrangement, the owner of a vehicle may receive revenue by allowing advertisements to be displayed on their vehicle. Typically, the vehicle bears a surface that provides a static advertisement such as a billboard and the like. However, this kind of advertising can be expensive to change (i.e. remove and replace with another static advertisement) and accordingly suffers from limited effectiveness.

More recently, mobile advertising displays for use on vehicles have been developed and are proving to be a more effective advertising medium. For example, video screens are utilized in New York taxicabs to provide video stream advertising on a video screen that is triggered when a passenger enters the cab (i.e. opens the passenger door). In this way, multiple advertising messages can be provided to the passenger. However, this type of advertising is not dynamic and accordingly, the effectiveness of the advertising provided is less than optimal.

### SUMMARY OF THE INVENTION

The invention provides in one aspect, an advertising system for displaying an advertisement on a mobile device having a display on the basis of a geographical characteristic of the mobile device, the interactive communication system comprising:
(a) a communications network connected to the mobile device;
(b) a memory connected to the communication network for storing the advertisement and an associated predetermined geographical characteristic value;
(c) a processor connected to the memory for:
   (i) selecting the advertisement based on whether the geographical characteristic of the mobile device matches the associated predetermined geographical characteristic value; and
   (ii) instructing the mobile device over the communications network to display the selected advertisement on the display of the mobile device.

In another aspect, the invention provides a method for displaying an advertisement on a mobile device having a display on the basis of a geographical characteristic of the mobile device, the method comprising:
(a) storing the advertisement and an associated predetermined geographical characteristic value;
(b) selecting the advertisement based on whether the geographical characteristic of the mobile device matches the associated predetermined geographical characteristic value; and
(c) instructing the mobile device to display the selected advertisement on the display of the mobile device.

In another aspect, the invention provides an advertising system for displaying an advertisement on a mobile device having a display on the basis of a calendar characteristic of the mobile device, the interactive communication system comprising:
(a) a communications network connected to the mobile device;
(b) a memory connected to the communication network for storing the advertisement and an associated predetermined calendar characteristic value;
(c) a processor connected to the memory for:
   (i) selecting the advertisement based on whether the calendar characteristic of the mobile device matches the associated predetermined calendar characteristic value; and
   (ii) instructing the mobile device over the communications network to display the selected advertisement on the display of the mobile device.

In another aspect, the invention provides a method for displaying an advertisement on a mobile device having a display on the basis of a calendar characteristic of the mobile device, the method comprising:
(a) storing the advertisement and an associated predetermined calendar characteristic value;
(b) selecting the advertisement based on whether the calendar characteristic of the mobile device matches the associated predetermined calendar characteristic value; and
(c) instructing the mobile device to display the selected advertisement on the display of the mobile device.

Further aspects and advantages of the invention will appear from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show some examples of the present invention, and in which:

FIG. 1 is a block diagram of the location based advertising system of the present invention;

FIG. 2 is a flowchart that illustrates the general operation of the advertising system of FIG. 1;

FIG. 3 is a flowchart that illustrates the operation of the location module of the advertising system of FIG. 1;

FIG. 4 is a flowchart that illustrates the operation of the routing module of the advertising system of FIG. 1;

FIG. 5 is a flowchart that illustrates the operation of the selection module of the advertising system of FIG. 1; and

FIG. 6 is a flowchart that illustrates the operation of the accounting module of the advertising system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

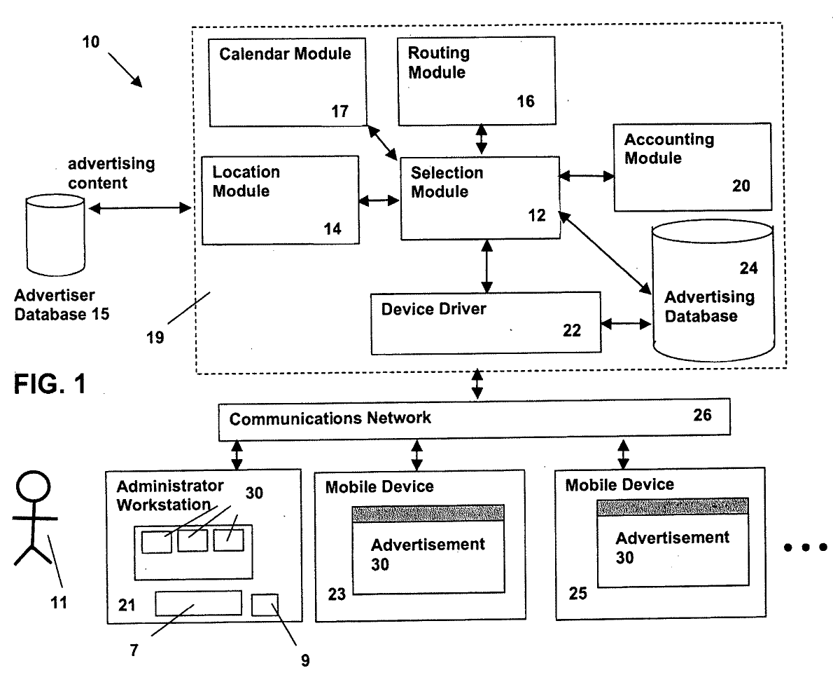

FIG. 1 illustrates an example of the geographical and calendar based advertising system and method 10. Advertising system 10 includes a selection module 12, a location module 14, a routing module 16, a calendar module 17, an accounting module 20, a display driver 22, and an advertising database 24. Advertising system 10 obtains advertising content from the advertiser database 15 and instructs a plurality of mobile devices 23 and 25 over communications network 26 to display various advertisements 30. Advertising system 10 determines which advertisements 30 should be displayed on the mobile devices 23 and 25 based on one or more geographical and/or calendar characteristics of the mobile devices 23 and 25. The geographical characteristics can include but are not limited to the physical location of the mobile device 23 or 25 and the destination or route plan of the mobile device 23 or 25 based on associated routing information, as will be further described. The calendar characteristics can include but are not limited to the date, time of day, day, week, month, year, holiday, daylight, darkness associated with the mobile device 23 or 25, as will be further described.

The selection module 12 receives advertising content from the advertiser database 15 through any viable electronic means and stores individual advertisements 30 along with associated advertising instructions within the advertising database 24. Once the advertisements 30 and their associated advertising instructions are stored in the advertising database 24, the selection module 12 utilizes the location module 14 and the routing module 16 to determine geographical characteristics of interest for the mobile devices 23, 25. If the geographical characteristics of the mobile device 23 or 25 fulfills the criteria set out by the advertising instructions associated with an advertisement 30 as stored within the advertising database 24, then selection module 12 instructs device driver to communicate with the mobile device 23 or 25 such that the advertisement is displayed on the mobile device 23 or 25, respectively.

The location module 14 is utilized to determine the geographical location of the mobile devices 23, 25. In an example implementation, the location module 14 works cooperatively with a GPS receiver and associated processing hardware and software associated with the mobile devices 23, 25 themselves (e.g. Zire 31 GPS Solution™ for PalmOne™ PDAs, manufactured by PalmOne of Milpitas, Calif.). Alternatively, in the case where a vehicle is hosting the mobile devices 23, 25 (e.g. the mobile devices 23, 25 are installed within taxicabs), the location module 14 would cooperate with a global positioning system (GPS) receiver and associated processing hardware and software (i.e. an In-Vehicle Navigation System (IVNS)) already installed within the hosting vehicle. Such geographical information is utilized by the selection module 12 to determine what advertisement to instruct the mobile devices 23, 25 to display.

The present invention encompasses the utilization of any of various known location determination systems such as any of those disclosed in U.S. Pat. No. 5,552,772, incorporated herein by reference. It should be understood that the geographical locating features of a GPS receiver could be alternatively accomplished using conventional cellular triangulation methods. In such a case, it would not be necessary to utilize a GPS receiver in association with mobile devices 23, 25.

Routing module 16 is utilized to obtain routing information from a navigational system associated with the mobile devices 23, 25. As discussed above, mobile devices 23, 25 can themselves be outfitted with a GPS receiver and associated route-planning software (e.g. Zire 31 GPS Solution™ for PalmOne™ PDAs, manufactured by PalmOne of Milpitas, Calif.). In such a case the routing module 16 cooperates directly with the mobile devices 23, 25 to determine the necessary routing information (e.g. destination, specific route being suggested, the specific route being taken, etc.) This information (as available) is then provided to the selection module 12 for analysis.

Alternatively, it is contemplated that a hosting vehicle will include either an In-Vehicle Navigation System (IVNS) that provides dynamic route guidance, map and turn-by-turn voice commands and/or an Integrated Driver Information System (IDIS) which combines IVNS with telematics to provide an advanced travel information system that includes real-time traffic information, route planning and emergency services. Commercially available examples of such systems include GM's OnStar™ system and Ford's emergency calling RESCU™ system. In addition, other in-vehicle navigation systems are currently being offered by third party equipment manufacturers (e.g. NavMan™ iCN 650 In-Car Navigation GPS manufactured by NavMan of New Zealand). In such a case the routing module 16 cooperates with these in-vehicle systems within the hosting vehicle to determine the necessary routing information (e.g. destination, specific route being suggested, the specific route being taken, etc.) This information (as available) is then provided to selection module 12 for analysis.

The calendar module 17 is responsible for providing various calendar related information (e.g. date, time of day, day, week, month, year, etc.) to the selection module 12. It is contemplated that calendar module 17 could be configured to monitor special dates (e.g. statutory holidays for the region at issue) and to distinguish between workdays and weekends. As well, calendar module 17 could be utilized to provide additional information such as whether the particular time falls within daylight or darkness according to a preprogrammed sunrise/sunset schedule. Some or all of these factors and others related to date/time conditions are utilized in part by selection module 12 to select suitable advertisements 30 from advertising database. In one example implementation, the calendar module 17 is simply a commercially available calendaring system and provides the date and the time of day. Alternatively, the calendar module 17 can be implemented by an international date/time monitoring system to enable the advertising system 10 to operate within various time zones in a seamless manner.

Accounting module 20 receives and manages statistical information associated with the display of advertisements 30 on mobile devices 23 and 25 and ensures that the most current version of this information is stored within advertising database 24. Accounting information includes the number of times that an advertisement 30 has been displayed, the times of day at which the advertisement 30 has been displayed, and the geographical characteristics associated with the mobile device 23 or 25 when the advertisement 30 was displayed.

Accounting module 20 preferably maintains tracking information on a mobile device by mobile device basis. This allows for the tracking of commissions for a particular hosting vehicle or stationary hosting structure on a per mobile device basis. It would for example, be possible to query advertising database 24 and obtain information on which specific advertisements 30 have been displayed on a particular mobile device 23 or 25 and at what times and associated geographical characteristics. This way, a specific commission can be associated with a particular mobile device 23 or 25 and a hosting vehicle or stationary hosting structure which houses the particular mobile device 23 or 25 can be credited accordingly. Of course, it is possible for a hosting vehicle or stationary hosting structure to house more than one mobile device 23 or 25, in which case multiple commissions would be credited.

Also, accounting module 20 tracks and maintains statistical information that can be used to determine royalty streams associated with the broadcast of an advertisement 30 across a number of mobile devices 23, 25. Typically, statistical information will be aggregated so that various measures (e.g. play volumes, frequency of play, etc.) can be determined on a per advertisement 30 basis. This kind of royalty stream information is used by the provider of the advertising system 10 to charge suitable advertising fees to advertisers. Also, this royalty stream information is provided to advertisers so that they can in turn compensate entities that have licensed content in the advertisements 30.

The device driver 22 in one example implementation is a conventional cellular modem that provides cellular communication between advertising system 10 and the mobile devices 23, 25. For example, display driver such as the MP210 multi-mode cellular modem (manufactured by Sierra Wireless Inc. of Richmond, British Columbia) uses Circuit Switched Cellular (CSC) and Cellular Digital Packet Data (CDPD) when available or the Sage cellular modem (manufactured by Novatel of San Diego, Calif.).

The advertising database 24 contains the various advertisements 30 provided by advertisers to the advertising system 10 along with advertising instructions. It is contemplated that advertising 30 includes multimedia content including full motion video, audio and high-resolution graphics. Each advertisement 30 is associated with a set of advertising instructions. Each set of advertising instructions include a list of target map regions in which it is desired for the advertisement 30 to be displayed. For example, it may be desired to display an advertisement 30 for medical related products and services in a target map region that has a high density of hospitals. In addition, each set of advertising instructions can optionally include calendar-related instructions during which it is desired for the advertisement 30 to be displayed. For example, for a target map region that includes many downtown stores and nightclubs, it may be desired to display a toy store advertisement 30 during the day an adult entertainment advertisement 30 in the evening. It is contemplated that the advertising system 10 will allow for the modification of these instructions to, in part, allow for advantage to be taken of the information generated by the accounting module 20, as will be described.

The communications network 26 in one example implementation is a cellular-based network that provides wireless communication between the advertising system 10 and the mobile devices 23, 25 through a bearer service provided through cellular node (not shown). It should be understood that the communications link may comprise a conventional cellular link, radio signal broadcast communication, or other known wireless communication systems.

The mobile devices 23, 25 may be any kind of display device that provides a display (e.g. LCD display, plasma display, etc.) and contains sufficient processing and memory resources to execute communication software that allows for communication between the mobile device 23, 25 and advertising server 19.

Preferably, the mobile devices 23, 25 utilize a multimedia display that provides a substantial impact on a viewer, especially if the mobile device 23 or 25 is adapted to be mounted on the outside surface of a hosting vehicle (e.g. taxicab) or on an stationary hosting structure (e.g. bus shelter) where the attention of a view must be caught. For example, the multimedia display can be any commercially available high contrast flat panel display, high contrast plasma display, and the like (e.g. the 18.1″ Digital SXGA manufactured by NEC). Also, if the mobile device 23 or 25 is mounted within, or on the outside surface of, a hosting vehicle, then a suitable protective enclosure (e.g. a secondary transparent hard plastic layer) should be utilized.

Alternatively and optionally, the mobile devices 23, 25 could be implemented by a personal computing device that includes some form of interactive user interface (e.g. display and keyboard interface, verbal command driven interface, or combinations thereof etc.) such as personal digital assistants (PDA's) (e.g. Blackberry™, manufactured by Research in Motion of Waterloo, Canada), Internet smart phones, personal laptop computers, and the like.

The administrator workstation 21 provides the administrator 11 with the ability to view and alter information associated with advertising instructions. The administrator workstation 21 includes a keyboard 7 and a user-pointing device 9 (e.g. mouse) as shown in FIG. 1. It should be understood that the administrator workstation 21 can be implemented by any wired or wireless personal computing device with input and display means (e.g. conventional personal computer, laptop computing device, personal digital assistant (PDA), etc.) The advertising system 10 is installed either on the hard drive of the user workstation 21 and/or on image server (not shown) such that administrator workstation 21 works with the advertising server 19 in a client-server configuration. As shown in FIG. 1, administrator workstation 21 preferably allows administrator 11 to display and manipulate a series of advertisements 30 in presentation order using keyboard 7 and mouse 9.

In one example of advertising system 10, the selection module 12, the location module 14, the routing module 16, the calendar module 17, the accounting module 20, the display driver 22, and the advertising database 24 are all implemented within an advertising server 19 and communicate with an administrator workstation 21 over the communications network 26 in a client-server formation. In this way, the operation of the advertising system 10 is controlled through an administrator workstation 21 that communicates with advertising server 19.

However, it should be understood that many other configurations are possible. For example, it is possible for the advertising system 10 to be implemented in a more distributed manner, where the selection module 12, the location module 14, the routing module 16, the calendar module 17, the accounting module 20, the display driver 22, and the advertising database 24 are implemented within or associated locally with the mobile devices 23, 25.

Another example would be where certain of these elements are located within or associated locally with the mobile devices 23, 25 and others are located on the advertising server 19 such that limited queries and instructions are provided over the communications network 26. For example, the mobile device 23 or 25 could be configured to send queries to the advertising server 19 that contain location coordinates (where advertising is selected based on the physical location of the mobile device) or ultimate destination or route plan (where advertising is selected based on the destination or route plan as determined by a vehicle's route planning software).

It should also be understood that the statistical information that is associated with a particular mobile device 23, 25 and that is received and managed by accounting module 20 and stored within advertising database 24 could be reproduced and made locally available within memory associated with the mobile device 23, 25 itself. This allows for specific commission (i.e. royalty stream) information to be obtained locally from each mobile device 23, 25 itself. Also, this would for example, allow for such information to be provided to an “on-board” display associated with a hosting vehicle (e.g. the dispatch call screen) so that a taxi driver could monitor commissions that are being generated on a regular basis.

Finally, it should be understood that advertising system 10 can operate on the basis of either geographical or calendar characteristics alone or in combination.

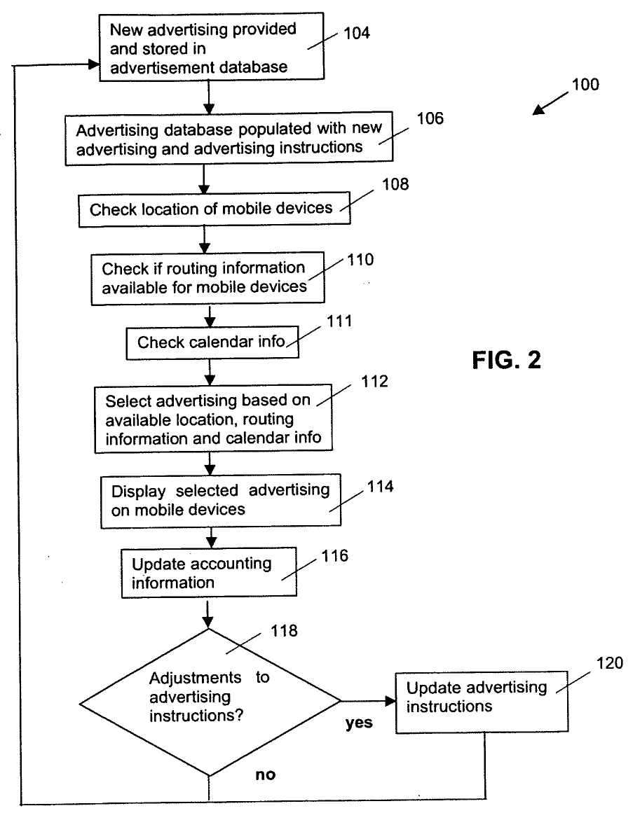

Referring now to FIGS. 1 and 2, the general operation of the advertising system 10 will now be discussed. Specifically, FIG. 2 is a flowchart that illustrates the processing steps 100 that are executed by advertising system 10.

At step (104), an advertisement 30 is provided by an advertiser and at step (106), the new advertisement 30 and associate advertising instructions are stored within advertising database 24.

Then at step (108), the location module 14 checks the location of the mobile devices 23, 25 utilizing the GPS equipment previously discussed. It should be understood that any of the mobile devices 23, 25 could be housed within either a hosting vehicle (e.g. a taxi) or a stationary hosting structure (e.g. a bus shelter or an advertising frame installed on a building, etc.) In the case where a mobile device 23 or 25 is housed within a stationary hosting structure, the location of the mobile device 23 or 25 would still be determined dynamically. It should be understood that the only geographical characteristic associated with a mobile device 23 or 25 housed within a stationary hosting structure would be it's physical location and that it would not typically change over time. The only time that the physical location of such a mobile device 23, 25 would change would be when it is physically relocated to another stationary hosting structure.

At step (110), routing module 16 determines whether routing information is available for the mobile devices 23, 25. Again, as noted above in the case where a mobile device 23 or 25 is housed within a stationary hosting structure, there will be no routing information available, only physical location.

At step (111), the calendar module 17 checks calendar related information such as date, time of day, day, week, month, and whether there is daylight or darkness, and the like, etc.

At step (112) the selection module 12 selects particular advertisements 30 for display on the mobile devices 23, 25. The particular selection process depends on what physical location and routing information is available for the mobile devices 23, 25, and what calendar related information is available from calendar module 17, as well as other factors implemented as queuing rules as will be described.

At step (114), the selected advertisements 30 are displayed on the mobile devices 23, 25. At step (116), accounting information associated with the advertisements 30 is determined and updated within the advertising database 24. As noted before, accounting information includes the number of times that the advertisement 30 is displayed, the times of day at which the advertisement 30 is displayed, and the geographical characteristics associated with the mobile device 23 or 25 when the advertisement 30 is displayed is compiled. All of this information is utilized to determine a commission for the hosting vehicle or stationary hosting structure and other related royalty streams associated with the broadcast of the advertisement 30. It should be understood that many other advertising performance metrics well known in the advertising field could be monitored, stored and analyzed by the accounting module 20 to optimize the presentation of advertisements 30 on the mobile devices 23, 25.

At step (118), the selection module 12 determines whether the administrator 11 has requested any modifications to the advertising instructions for any advertisements 30. If not, then steps (108) to (116) discussed above are re-executed. If so, then at step (120), the selection module 12 updates the advertising instructions within the advertising database 24 in accordance with the requested modifications.

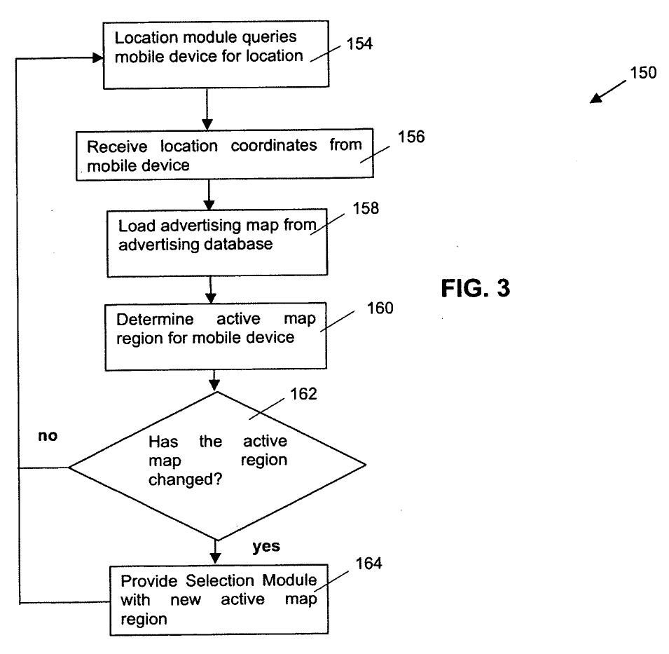

Referring now to FIGS. 1, 2, and 3, the specific operation of the location module 14 will be described. Specifically, FIG. 3 is a flowchart that illustrates the operational steps 150 of the location module 14.

At step (154), the location module 14 queries a mobile device 23 or 25 to obtain its geographical location. At step (156), the location module 14 receives location coordinates from the mobile device 23 or 25. As discussed above, the mobile device 23 or 25 could be outfitted with a GPS receiver in which case the location module 14 cooperates directly with the mobile devices 23, 25 to determine the necessary location information. Alternatively, in the case where there is a hosting vehicle, the location module 14 will communicate directly with the In-Vehicle Navigation System (IVNS) installed within the hosting vehicle.

At step (158), the location module 14 loads an advertising map maintained and stored within the advertising database 24. It is contemplated that the advertising map will consist of regions that represent geographical areas of interest to advertisers. For example, an advertising map that represents New York could be broken down into a number of regions (e.g. Greenwich Village, Chelsea, Upper West Side, Upper East Side, etc.), each region representing a different area of interest for advertisers. It should be understood that regions could be further subdivided into small geographical areas (e.g. a square city block) as desired.

At step (160), the location module 14 determines the active map region for the mobile device 23 or 25 based on the location coordinates provided in step (156) and the advertising map discussed. At step (162), it is determined whether the active map region associated with the mobile device 23 or 25 has changed since the last evaluation. That is, it is determined whether the mobile device 23 or 25 has crossed over from one active map region to another. If not, then steps (154) to (160) are repeated for each mobile device 23 or 25. If not, then at step (164), the location module 14 provides the selection module 12 with the new active map region for the mobile device 23 or 25 and steps (154) to (160) are repeated are repeated for each mobile device 23 or 25.

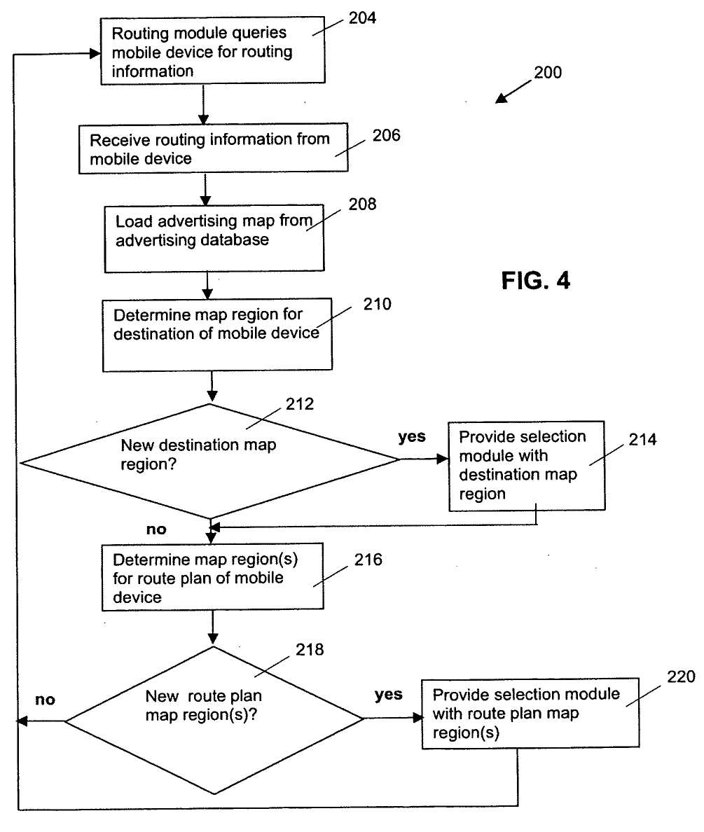

Referring now to FIGS. 1, 2, and 4, the specific operation of the routing module 16 will be described. Specifically, FIG. 4 is a flowchart that illustrates the operational steps 200 of the routing module 16.

At step (204), the routing module 16 queries a mobile device 23 or 25 to obtain its routing information. At step (206), the routing module 16 receives routing information from the mobile device 23 or 25. As discussed above, mobile device 23 or 25 could be outfitted with a GPS receiver and associated route-planning software in which case the routing module 16 cooperates directly with the mobile devices 23, 25 to determine the necessary routing information. Alternatively, in the case where there is a hosting vehicle, the routing module 16 will communicate directly with the In-Vehicle Navigation System (IVNS) installed within the vehicle to obtain routing information for the mobile device 23 or 25.

At step (208), the routing module 16 loads the advertising map maintained and stored within advertising database 24. As before, it is contemplated that the advertising map will consist of regions that represent geographical areas of interest to advertisers. The routing module 16 compares destination and route plan information associated with the mobile devices 23, 25 to the advertising map to determine the destination map region and the route plan map region(s).

At step (210), the routing module 16 determines the destination map region associated with the destination of the mobile device 23 or 25 by comparing the routing information provided in step (206) to the advertising map. Once the destination map region for the mobile device 23 or 25 is known, advertisements 30 that relate to businesses within the destination map region will be considered for display on the mobile device 23 or 25 by the selection module 12 in combination with time of day information, as will further described.

At step (212), the routing module 16 determines whether the identified destination map region is new. That is, it is determined whether the destination map region is different than that previously associated with mobile device 23 or 25 (i.e. has a new destination been established or has the existing destination changed?) If so, then at step (214), the routing module 16 provides selection module 12 with the new destination map region and then proceeds to step (216) discussed below. If the destination map region is not new, then routing module 16 proceeds directly to step (216).

At step (216), the routing module 16 determines the active map region(s) associated with the route plan of the mobile device 23 or 25. This is accomplished by comparing the routing information provided in step (206) to the advertising map. That is, it is contemplated that a route plan for a mobile device 23 or 25 may traverse one or more active map regions (i.e. for a trip from Brooklyn to the Upper West Side in the New York example) triggering the opportunity to provide advertisements 30 that relate to businesses en route, as will further described.

At step (218), it is determined whether the route plan map region(s) associated with the route plan are new. That is, it is determined whether the route plan map region(s) are different than that previously associated with mobile device 23 or 25 (i.e. has a new route plan been established or has the existing route plan changed?) If so, then at step (220), the new route plan map region(s) are provided to the selection module 12 and steps (204) to (218) are repeated for each mobile device 23 or 25. If the route plan map region(s) is not new, then routing module 16 proceeds directly to step (204) and repeats steps (204) to (218) for each mobile device 23 or 25.

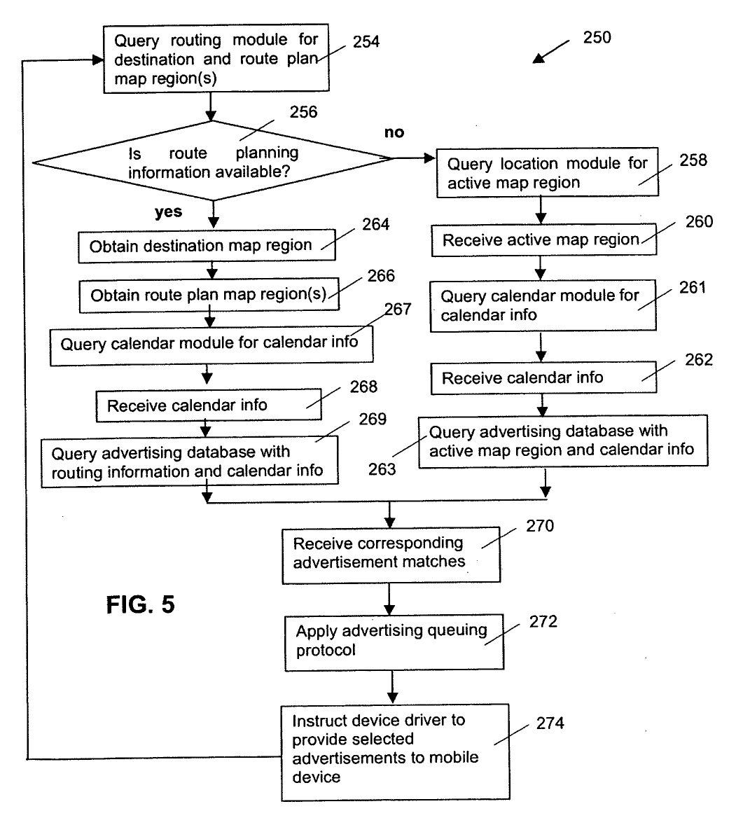

Referring now to FIGS. 1, 2, and 5, the specific operation of the selection module 12 will be described. Specifically, FIG. 5 is a flowchart that illustrates the operational steps 250 of the selection module 12.

At step (254), the selection module 12 queries routing module for destination and route plan map region(s) associated with the mobile device 23 or 25. At step (256), it is determined whether route planning information (e.g. destination and route plan) is available for the mobile device 23 or 25. It should be understood that route planning information also typically includes the physical location of the mobile device 23, 25 along with routing information (i.e. destination, suggested route etc.) for the mobile device 23, 25.

If not, then at step (258), the selection module 12 queries the location module 14 to obtain active map region for the mobile device 23 or 25. At step (260), the selection module 12 receives the active map region from the location module 14. As discussed before, the active map region for a mobile device 23 or 25 is the map region within which the mobile device 23 or 25 is geographically positioned.

At step (261), the selection module 12 queries the calendar module 17 to obtain date/time of day and other calendar related information as discussed above. At step (262), the selection module 12 receives this information.

At step (263), the selection module 12 queries the advertising database 24 using the active map region and the calendar related information. This is done to identify advertisements 30 with advertising instructions that match the active map region and which suit the calendar related information.

If route planning information is available, then at step (264) the selection module 12 queries the routing module 16 and obtains the destination map region for the mobile device 23 or 25. At step (266), the selection module 12 queries the routing module 16 and obtains the route plan map region(s) for the mobile device 23 or 25.

At step (267), the selection module 12 queries the calendar module 17 to obtain the date/time of day and other calendar related information as discussed above. At step (268), the selection module 12 receives this information.

At step (269), the selection module 12 queries the advertising database 24 using the routing information, namely the destination map region and the route plan map region(s) as well as the calendar related information discussed above.

As discussed above, when the advertising database 24 is queried with routing and the calendar related information, the advertising database 24 performs a matching process to identify suitable advertisements 30 for consideration by the selection module 12. Specifically, any advertisement 30 within the advertising database 24 that has advertising instructions that include the destination map region or the route path map region(s) as target region(s) as well as advertising instructions that match the calendar related information will be identified as a prospective advertisement 30 and provided to the selection module 12.

As discussed above, each advertisement 30 is associated with a set of advertising instructions. The advertising instructions include a list of preferred map regions in which it is desired for the advertisement 30 to be displayed. They also include calendaring conditions during which it is desired to display the advertisements 30. If the mobile device 23 or 25 is present within an active map region that is a preferred map region for a particular advertisement 30 and if the calendaring conditions are met then advertising database 24 will consider the particular advertisement 30 to be a “match”. Advertising database 24 will then send the selection module 12 a list of such matched advertisements 30 for consideration. A discussion of how selection module 12 further processes these matched advertisements 30 will be discussed further in relation to steps (270) to (274) below.

At step (270), the selection module 12 receives corresponding advertisement matches from the advertising database 24. At step (272), the selection module 12 applies an advertising queuing protocol that performs additional analysis on all of the advertisements 30 that have been identified for consideration by selection module 12. This advertising queuing protocol could be implemented by any commercially utilized queuing protocol (e.g. those utilized by commercial radio and television stations and the like). In addition, it is contemplated that additional advantageous selection rules could be established by administrator 11 over administrator workstation 21 to control the sequencing and selection of advertisements 30. For example, the advertising queuing protocol could include a mechanism to prevent certain messages from being displayed inappropriately, based on the geographical location or the calendar related information associated with the mobile device 23 or 25.

At step (274), the selection module 12 instructs the device driver 22 to provide the selected advertisements 30 from step (272) to the mobile device 23 or 25 for display.

It should be understood that while this example implementation of the advertising system 10 is being described in relation to routing information that includes the destination map region and the route plan map region(s), many other types of routing information that is gathered, calculated and applied by commercial route planning systems could be utilized within the advertising system 10.

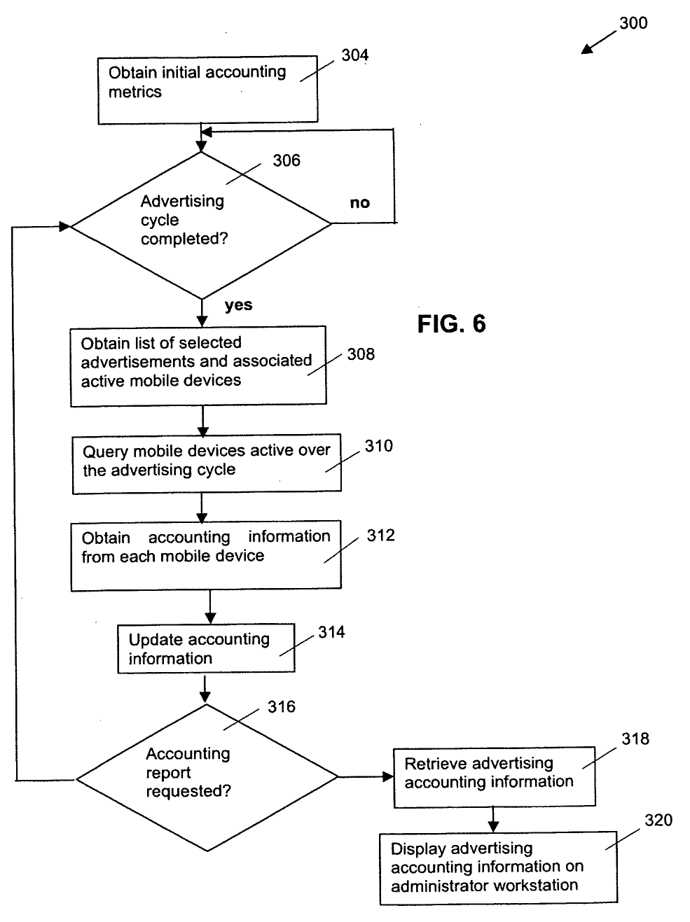

Referring now to FIGS. 1, 2, and 6, the specific operation of the accounting module 20 will be described. Specifically, FIG. 6 is a flowchart that illustrates the operational steps 300 of the accounting module 20.

At step (304), the accounting module 20 obtains initial accounting metrics. As noted before, accounting information can include the number of times that the advertisement 30 is displayed, the time of day (or days of the week) at which the advertisement 30 is displayed, the duration of display, and the geographical characteristics associated with the mobile device 23 or 25 when the advertisement is displayed is compiled. It should be understood that many other advertising metrics well known in the advertising field could be monitored, stored and analyzed by accounting module 20 to optimize the display of advertisements 30 on mobile devices 23, 25.

As discussed above, it is contemplated that it is of interest to maintain records concerning the play volume of various advertisements 30 on particular mobile devices 23, 25 in order to determine commissions for hosting vehicles or stationary hosting structures on a mobile device by mobile device basis. This way, a specific commission can be associated with a particular mobile device 23 or 25 and a hosting vehicle or stationary hosting structure which houses the particular mobile device 23 or 25 can be credited accordingly.

Also, accounting module 20 tracks and maintains statistical information that can be used to determine royalty streams associated with the broadcast of an advertisement 30 across a number of mobile devices 23, 25. Typically, statistical information will be aggregated so that various measures (e.g. play volumes, frequency of play, etc.) can be determined on a per advertisement 30 basis. This kind of information can then be used by the provider of the advertising system 10 to charge suitable advertising fees to advertisers. Also, this royalty stream information is provided to advertisers so that they can in turn compensate entities that have licensed content in the advertisements 30. Finally, various types of advertising accounting information concerning the utilization and exposure of advertisements 30 may be desired by advertisers in order to determine the effectiveness of advertising campaigns etc.

At step (306), the accounting module 20 determines whether the advertising cycle has been completed. In the example implementation of the advertising system 10, an advertising cycle is considered to be a day (24 hours) although it should be understood that the advertising cycle could be any period of time. At step (308), the accounting module 20 obtains a list of all of the advertisements 30 selected by selection module 12. The accounting module 20 also obtains a list of all of the active mobile devices 23, 25 on which the advertisements 30 have been displayed.

At step (310), the accounting module 20 queries each of the mobile devices 23, 25 on the list of mobile devices 23, 25 obtained at step (308). At step (312), the accounting module 20 obtains the types of accounting information as established in step (304) from each of these mobile devices 23, 25. At step (314), the accounting module 20 updates the accounting records maintained within advertising database 24. At step (316) it is determined whether an accounting report has been requested by administrator workstation 21. If so, then step (318), the accounting module 20 retrieves the current advertising administrative information from advertising database 24.

Finally, at step (320), the accounting module 20 accesses information from the advertising database 24. Specifically, as discussed above, advertising database 24 keeps the data log records of which advertisements 30 have been displayed, for how long, how often, where, when, etc., and displays this information on the administrator workstation 21. This information can be utilized in order that a royalty stream may be developed for the advertisements 30 displayed.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An advertising system for displaying an advertisement on a mobile device having a display on the basis of a geographical characteristic of the mobile device, the interactive communication system comprising:
(a) a communications network connected to the mobile device;
(b) a memory connected to the communication network for storing the advertisement and an associated predetermined geographical characteristic value;
(c) a processor connected to the memory for:
(i) selecting the advertisement based on whether the geographical characteristic of the mobile device matches the associated predetermined geographical characteristic value; and
(ii) instructing the mobile device over the communications network to display the selected advertisement on the display of the mobile device.

2. The advertising system of claim 1, wherein the geographical characteristic is the physical location of the mobile device.

3. The advertising system of claim 2, wherein the physical location of the mobile device is determined by a global positioning system.

4. The advertising system of claim 2, wherein the physical location of the mobile device is determined by a cellular triangulation system.

5. The advertising system of claim 1, wherein the processor further receives routing information from the mobile device, said routing information including a route destination, and wherein the geographical characteristic is the physical location of the route destination.

6. The advertising system of claim 1, wherein the processor further receives routing information from the mobile device, said routing information including a route plan, and wherein the geographical characteristic is the set of physical locations associated with the route plan.

7. The advertising system of claim 1, wherein the mobile device is also associated with a calendar characteristic, the memory further stores an associated predetermined calendar characteristic value, and the processor further selects an advertisement based on whether the calendar characteristic of the mobile device matches the associated predetermined calendar characteristic value.

8. The advertising system of claim 7, wherein the calendar characteristic is selected from the group consisting of: date, time of day, day, week, month, year, holiday, daylight, darkness.

9. The advertising system of claim 1, wherein the processor further determines advertising accounting information associated with the display of the selected advertisement on the mobile device over an advertising cycle.

10. The advertising system of claim 9, wherein the accounting information includes the number of times that the advertisement is displayed on the mobile device over the advertising cycle.

11. The advertising system of claim 9, wherein the accounting information includes the times of day at which the selected advertisement is displayed on the mobile device over the advertising cycle.

12. The advertising system of claim 9, wherein the accounting information includes the geographical characteristics associated with the mobile device when the selected advertisement is displayed on the mobile device over the advertising cycle.

13. A method for displaying an advertisement on a mobile device having a display on the basis of a geographical characteristic of the mobile device, the method comprising:
(a) storing the advertisement and an associated predetermined geographical characteristic value;
(b) selecting the advertisement based on whether the geographical characteristic of the mobile device matches the associated predetermined geographical characteristic value; and
(c) instructing the mobile device to display the selected advertisement on the display of the mobile device.

14. The method of claim 13, wherein the geographical characteristic is the physical location of the mobile device.

15. The method of claim 14, wherein the physical location of the mobile device is determined by a global positioning system.

16. The method of claim 14, wherein the physical location of the mobile device is determined by a cellular triangulation system.

17. The method of claim 13, further comprising receiving routing information from the mobile device, said routing information including a route destination, and wherein the geographical characteristic is the physical location of the route destination.

18. The method of claim 13, further comprising receiving routing information from the mobile device, said routing information including a route plan, and wherein the geographical characteristic is the set of physical locations associated with the route plan.

19. The method of claim 13, wherein the mobile device is also associated with a calendar characteristic, the memory further stores an associated predetermined calendar characteristic value, and the processor further selects an advertisement based on whether the calendar characteristic of the mobile device matches the associated predetermined calendar characteristic value.

20. The method of claim 19, wherein the calendar characteristic is selected from the group consisting of: date, time of day, day, week, month, year, holiday, daylight, darkness.

21. The method of claim 13, further comprising determining advertising accounting information associated with the display of the selected advertisement on the mobile device over an advertising cycle.

22. The method of claim 21, wherein the accounting information includes the number of times of day that the advertisement is displayed on the mobile device over the advertising cycle.

23. The method of claim 21, wherein the accounting information includes the times at which the selected advertisement is displayed on the mobile device over the advertising cycle.

24. The method of claim 21, wherein the accounting information includes the geographical characteristics associated with the mobile device when the selected advertisement is displayed on the mobile device over the advertising cycle.

25. An advertising system for displaying an advertisement on a mobile device having a display on the basis of a calendar characteristic of the mobile device, the interactive communication system comprising:
(a) a communications network connected to the mobile device;
(b) a memory connected to the communication network for storing the advertisement and an associated predetermined calendar characteristic value;
(c) a processor connected to the memory for:
(i) selecting the advertisement based on whether the calendar characteristic of the mobile device matches the associated predetermined calendar characteristic value; and
(ii) instructing the mobile device over the communications network to display the selected advertisement on the display of the mobile device.

26. The advertising system of claim 25, wherein the calendar characteristic is selected from the group consisting of: date, time of day, day, week, month, year, holiday, daylight, darkness.

27. The advertising system of claim 25, wherein the processor further determines advertising accounting information associated with the display of the selected advertisement on the mobile device over an advertising cycle.

28. The advertising system of claim 27, wherein the accounting information includes the number of times that the advertisement is displayed on the mobile device over the advertising cycle.

29. The advertising system of claim 27, wherein the accounting information includes the times of day at which the selected advertisement is displayed on the mobile device over the advertising cycle.

30. The advertising system of claim 27, wherein the accounting information includes the geographical characteristics associated with the mobile device when the selected advertisement is displayed on the mobile device over the advertising cycle.

31. A method for displaying an advertisement on a mobile device having a display on the basis of a calendar characteristic of the mobile device, the method comprising:
(a) storing the advertisement and an associated predetermined calendar characteristic value;
(b) selecting the advertisement based on whether the calendar characteristic of the mobile device matches the associated predetermined calendar characteristic value; and
(c) instructing the mobile device to display the selected advertisement on the display of the mobile device.

32. The method of claim 31, wherein the calendar characteristic is selected from the group consisting of: date, time of day, day, week, month, year, holiday, daylight, darkness.

33. The method of claim 31, further comprising determining advertising accounting information associated with the display of the selected advertisement on the mobile device over an advertising cycle.

34. The method of claim 33, wherein the accounting information includes the number of times of day that the advertisement is displayed on the mobile device over the advertising cycle.

35. The method of claim 33, wherein the accounting information includes the times at which the selected advertisement is displayed on the mobile device over the advertising cycle.

36. The method of claim 33, wherein the accounting information includes the geographical characteristics associated with the mobile device when the selected advertisement is displayed on the mobile device over the advertising cycle.
